(19) United States
(12) Patent Application Publication
(10) Pub. No.: US 2007/0291742 A1
(43) Pub. Date: Dec. 20, 2007

(54) Method for Configuring a Device Using Dhcp Via Pppoe

(75) Inventors: Michael Schenk, Hettlingen (CH); Walter Schweizer, Zuerich (CH)

Correspondence Address: SIEMENS SCHWEIZ AG;I-47, INTELLECTUAL PROPERTY, ALBISRIEDERSTRASSE 245, ZURICH, CH-8047, CH

(73) Assignee: SIEMENS SCHWEIZ AG, ZUERICH (CH)

(21) Appl. No.: 11/666,472

(22) PCT Filed: Oct. 27, 2005
(86) PCT No.: PCT/EP05/11502

§ 371 Date: Apr. 26, 2007

(30) Foreign Application Priority Data
Nov. 26, 2004 (EP) 04028083.6

(51) Int. Cl. H04L 29/12

(52) U.S. Cl. 370/352

(57) ABSTRACT

In a method for configuring a device with a DHCP protocol, wherein the device is in communication with an access server via a PPPoE protocol, a session is started by the access server. An IP address is assigned to the device. A previously unknown IP address of a DHCP server is transmitted to the device, wherein the DHCP server provides for a DHCP service and a DNS service. An IP address of the DNS service is equated with the IP address of the DHCP server. A directed DHCP request is sent from the device to the IP address for the DNS service.

The present invention relates to a method for configuring a device with the protocol DHCP via the protocol PPPoE in accordance with the preamble of claim 1.

To avoid lack of clarity and in the interests of using precise technical language, the original German document and this English translation both refer to the English technical terms and widely-used acronyms. For an explanation of the technical terms and acronyms used the reader is referred to the list provided at the end of this document which forms an integral part of this document. DHCP is an acronym for “Dynamic Host reconfiguration Protocol” in accordance with RFC 2131 (March 1997) and PPPoE for Point-to-Point Protocol over Ethernet.

The term device in the sense of communication technology is taken to mean a subscriber device via which a service can be handled, e.g. speech or data transmission.

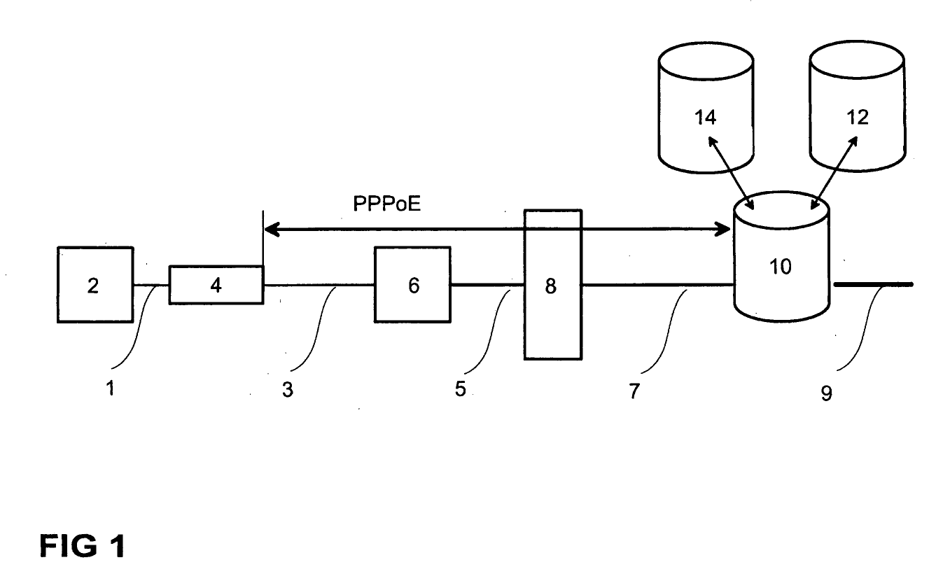

With regard to the nomenclature used in this document, the publications “DSL Forum Technical Report” TR-044 [1] and “DSL Forum Technical Report” TR-046 [2] form an integrating component thereof. In the above context this concerns the area of connection of subscriber devices and of broadband network terminations B-NT—also called set top boxes—to an Internet service. As shown in FIG. 1, a subscriber device 2 is connected to a network termination device B-NT 4, which for its part is connected via an xDSL link 3 to a “Broadband Remote Access Server” 10. The server 10 is also abbreviated to “BRAS” below. On layer 3 communication takes place between B-NT 4 and BRAS 10 with the protocol PPPoE. This requires an IP address to be allocated to the device 4 or to the set top box 4. As well as issuing an IP address and the address of the DNS server, which is done by PPPoE, the set top box 4 is to be remotely configured with the protocol DHCP. From the standardization in accordance with “DSL Forum Technical Report” TR-044 [1] the following solution is provided: A message “DHCP_INFORM” is sent from the set top box 4 to the BRAS 2, see para. 4.1.4 in [1] for more details. If the protocol PPPoE is used however, a DHCP Relay Agent is required in the BRAS since the request (=message) is sent as a broadcast. From the routers used, such as the BRAS 10 for example, broadcast messages are not supported under protocol PPPoE or even filtered, see para. 6.1 of the “DSL Forum Technical Report” TR-044 [1] for more details.

In the sense of this publication the term device is used as a generic term for any device which is connected via the protocol PPPoE to an access server. For example such a device (as stated previously) is a broadband network termination device including an xDSL modem, this device can however also perform a specific function, e.g. as router or set top box. In this case an xDSL modem is always included to insure the layer 1 function.

The underlying object of the present invention is now to specify a method for configuring a device with the protocol DHCP which avoids the restrictions specified above.

In accordance with the invention this object is achieved by the method specified in claim 1.

In accordance with the inventive method, by which
A The device sends a directed request to the address for the DNS service,
B The address of the DNS service is equated with the address of the DHCP server (14);
   a method is created in which no multicast/broadcast has to be sent from the device to be configured to the access server. This is achieved by equating the IP address of the DHCP server with the IP address of the DNS service.

Advantageous embodiments and implementations of the inventive method are specified in further claims.

An exemplary embodiment of the invention is explained in greater detail below with reference to the drawing. The figures show:

FIG. 1 A basic diagram of the connection of a set top box to an access server;

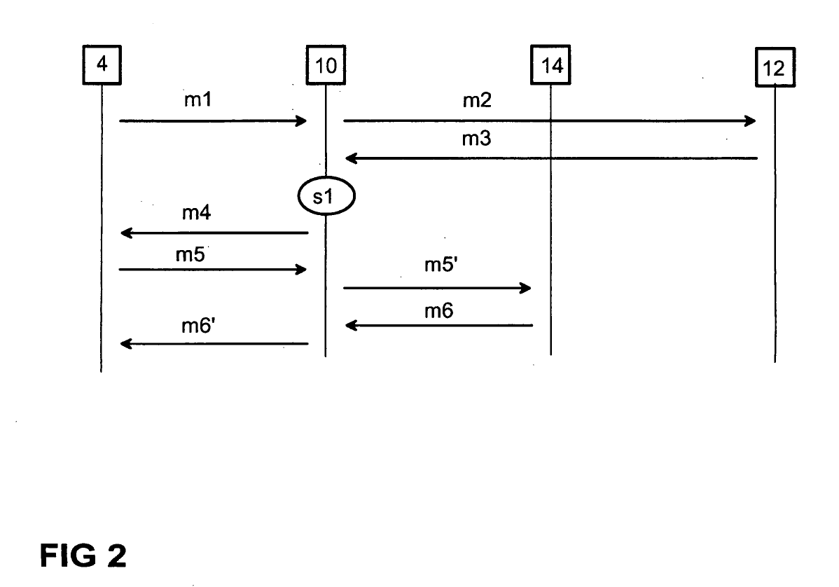

FIG. 2 The message sequence.

FIG. 1 shows a basic diagram of the connection of a set top box 4 to an access server 10, for which communication is handled via the protocol PPPoE. Only those elements are explained here which are absolutely necessary for understanding an embodiment of the present invention. FIG. 1 encompasses a plurality of devices 4 to be configured, but only a single device 4 is shown. For the allocation of addresses to the devices 4 to be configured there is advantageously provision for the access server 10 to have a specific address book available which is adapted to the number of simultaneously connected devices 4.

The message sequence during execution of a preferred embodiment of the inventive method can be found in FIG. 2 and in detail includes the following:
m1 Establishing a PPPoE session between device 4 and BRAS 10.
m2 Request for authentication to the service RADIUS 12.
m3 Response to BRAS 10 with the content authentication OK/failed.
S1 BRAS 10 opens session on a successful authentication; BRAS 10 has available a predetermined, but selectable IP address area.
m4 BRAS 10 allocates device 4 an IP address from a predetermined address range, in addition the DNS address (for name resolution) is contained in the message m4, which is identical to the DHCP address.
m5 Device 4 sends a directed message (unicast) DHCP_Inform to BRAS 10.
m5′ Since the message m5 is directed, it is forwarded to the DHCP server. The DNS service can be reached under the same address however.
m6 DHCP_Inform response is transferred by DHCP service to BRAS.
m6′ Message m6 is forwarded from BRAS 10 to device 4 and the device can be configured on the basis of the DHCP_Inform response.

As already explained above under message m4, the services DHCP and DNS have the same IP address. These can run on the same server since they differ through their port numbers.

In addition to the basic settings made for the device 4 with its IP address and the DNS address by the access server, further settings can be provided, such as boot file and time server for example. These settings are made by DHCP server 12

The above exemplary embodiment related to a broadband network termination device B-NT. The invention can however be used for a set top box or a router for a integrated access device IAD.

### LIST OF REFERENCE SYMBOLS USED

1 LAN, Ethernet
2 Computer, terminal, device, subscriber device
3 xDSL link
4 Set top box including xDSL modem, broadband network termination device.
5 SDH
6 DSLAM
7 ATM Access, Ethernet over ATM
8 ATM concentrator
9 IP Core
10 BRAS, Broadband Remote Access Server; Access server
12 RADIUS, Remote Access Dial in User Service
14 Servers subdivided into DHCP servers or DHCP services and DNS services
m1 Establish PPPoE session
m2 Request for authentication
m3 Response to request m2
m4 Response to m1: Allocation of an IP address for the device, additional IP address with address of the DNS service=address of the DHCP server
m5, m5′ Directed request for name resolution, is forwarded by BRAS to DNS.
m6, m6′ Response→DHCP parameter list

### LIST OF THE ABBREVIATIONS AND ACRONYMS USED

ATM Asynchronous Transfer Mode
B-NT Broadband Network Termination, broadband network termination device; set top box
BRAS Broadband Remote Access Server; access server
DHCP Abbreviation for Dynamic Host Configuration Protocol.
DHCP allows a network connected to the Internet to allocated different settings to a host if the host establishes a connection with the network.
DNS Abbreviation for “Domain Name System”. The system through which the Hosts in the Internet possess both domain addresses (e.g. bluestem.prairienet.org) and also IP addresses (e.g. 192.17.3.4). The domain address is used by users and automatically converted into the numeric IP address which is used by the software for forwarding packets.
“DNS” is also the abbreviation for “Domain Name Service” and represents the Internet service program which implements the domain name system (see above under DNS). DNS servers, also called name servers, administer the database with the addresses. The users can access the servers transparently.
DSLAM Digital Subscriber Line Access Multiplexer
IAD Integrated Access Device
IP Internet Protocol
LAN Local Area Network
PPPoE Point-to-Point Protocol over Ethernet
RADIUS Remote Access Dial In User Service
SDH Synchronous Digital Hierarchy
STB Set Top Box
xDSL Digital Subscriber Line

### LIST OF PUBLICATIONS CITED; INFORMATION ON SOURCES

[1] DSL Forum Technical Report TR-044 Auto-Configuration for Basic Internet (IP-based) Services; December 2001 Source http://www.dslforum.org
[2] DSL Forum Technical Report TR-046 Auto-Configuration Architecture & Framework (IP-based) Services; February 2002 Source http://www.dslforum.org

1.-6. (canceled)

7. A method for configuring a device with a DHCP protocol, wherein the device is in communication with an access server via a PPPoE protocol, comprising:
starting a session by the access server;
assigning an IP address to the device;
transmitting a previously unknown IP address of a DHCP server to the device, wherein the DHCP server provides for a DHCP service and a DNS service;
equating an IP address of the DNS service with the IP address of the DHCP server; and
sending a directed DHCP request from the device to the IP address for the DNS service.

8. The method of claim 7, further comprising performing an authentication of the device through a further service prior to sending the directed DHCP request.

9. The method of claim 8, wherein the further service is a RADIUS service.

10. The method of claim 8, wherein the device is only assigned an IP address if the authentication is performed successfully.

11. The method of claim 9, wherein the access server features a predetermined range of addresses, from which an allocation of an IP address for the device is undertaken.

12. The method of claim 7, wherein the DHCP and DNS services run on the same server, and differ through port numbers.

13. The method of claim 7, wherein further settings are made by the DHCP server.

14. The method of claim 13, wherein the further settings include a boot file and a time server.
